(19) United States
(12) Patent Application Publication
(10) Pub. No.: US 2008/0162131 A1
(43) Pub. Date: Jul. 3, 2008

(54) BLOGCASTING USING SPEECH RECORDED ON A HANDHELD RECORDING DEVICE

(76) Inventors: William K. Bodin, Austin, TX (US); David Jaramillo, Lake Worth, FL (US); Jesse W. Redman, Cedar Park, TX (US); Derral C. Thorson, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/619,253

(22) Filed: Jan. 3, 2007

(51) Int. Cl. G10L 15/26

(52) U.S. Cl. 704/235; 704/E15.043

(57) ABSTRACT

Methods, systems, and computer program products are provided for blogcasting. Embodiments include receiving, by a blog management system, a blog entry, the blog entry comprising speech recorded on a handheld recording device in a media file; converting the recorded blog entry to text; identifying, in dependence upon the text, blog content; and publishing the blog content.

### BACKGROUND OF THE INVENTION

1. Field of the Invention

The field of the invention is data processing, or, more specifically, methods, systems, and products for blogcasting using speech recorded on a handheld recording device.

2. Description of Related Art

Blogs or Web logs are increasingly being used as vehicles of expression by users. Conventional blogs, however, require a user to maintain the blog using conventional mechanisms such as logging onto the hosting website and adding or deleting content using the keyboard and mouse of a local computer. Such blog maintenance is time and device constrained. There therefore is a need for improvement in blogging.

### SUMMARY OF THE INVENTION

Methods, systems, and computer program products are provided for blogcasting. Embodiments include receiving, by a blog management system, a blog entry, the blog entry comprising speech recorded on a handheld recording device in a media file; converting the recorded blog entry to text; identifying, in dependence upon the text, blog content; and publishing the blog content.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for blogcasting according to embodiments of the present invention.

FIG. 2 sets forth a block diagram of automated computing machinery comprising an exemplary blog management system useful in blogcasting according to embodiments of the present invention.

FIG. 3 sets forth a flow chart illustrating an exemplary method for blogcasting according to embodiments of the present invention.

For further explanation, therefore, FIG. 4 sets forth a flow chart illustrating a method for identifying, in dependence upon the text, blog content and a method for publishing the blog content.

FIG. 5 sets forth another method for publishing blog content.

### DETAILED DESCRIPTION OF EXEMPLARY EMBODIMENTS

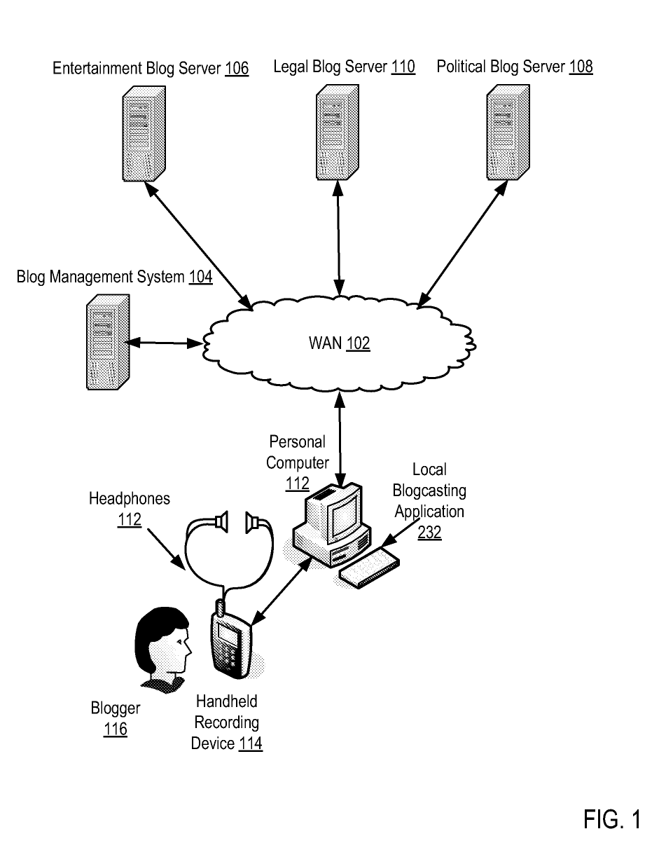

Exemplary methods, systems, and products for blogcasting in accordance with the present invention are described with reference to the accompanying drawings, beginning with FIG. 1. FIG. 1 sets forth a network diagram of a system for blogcasting according to embodiments of the present invention. A blog is a collection of entries often made in journal style any typically displayed in reverse chronological order. Blogs are published on a website and often provide commentary or news on a particular subject, such as food, politics, or local news or often function as more personal online diaries. The term “blog” is a derivative of another term “Web log.” In this specification, the term blog and Web log are used synonymously. The term blogcasting as used in this specification generally means to maintaining or adding content to a blog.

The system of FIG. 1 is capable of blogcasting according to the present invention by recording in a media file by a handheld recording device (114) a blog entry, the blog entry being speech dictated by a blogger (116); transmitting the media file to a blog management system (104); receiving, by the blog management system (104), the blog entry in the media file; converting the recorded blog entry to text; identifying, in dependence upon the text, blog content; and publishing the blog content on one or more of the destination blog servers (106, 110, and 108).

The system of FIG. 1 includes to a personal computers (112) coupled for data communications to a wide area network (‘WAN’) (102). The personal computer (112) of FIG. 1 has installed upon it a local blogcasting application (232). The local blogcasting application (232) includes computer program instructions capable of receiving media files containing blog entries dictated by a blogger (116) from the handheld recording device (114) and transmitting the media files to a blog management system (104).

The example of FIG. 1 also includes a blog management system (104). The blog management system of FIG. 1 is capable of blogcasting according to the present invention by receiving a blog entry in a media file recorded on the handheld recording device (114); converting the recorded blog entry to text; identifying, in dependence upon the text, blog content; and publishing the blog content on one or more of the destination blog servers (106, 110, and 108).

The exemplary system of FIG. 1 includes a handheld recording device (114) capable of recording blog entries dictated from a blogger (116). The handheld recording device includes a microphone for receiving speech of the blog entry and is capable of recording the blog entry in a media file. One handheld recording device useful according to embodiments of the present invention is the WP-U2J available from Samsung.

The exemplary system of FIG. 1 is capable of transferring the media file containing the recorded blog entry from the handheld recording device (108) to the local blogcasting application (232). Media files containing one or blog entries may be transferred to the local blogcasting application by periodically synchronizing the handheld recording device with the local blogcasting application allowing a blogger to begin transmission of the blog entries at the convenience of the blogger.

The exemplary system of FIG. 1 is also capable of transferring the media file containing the blog entry to a blog management system (104). The blog management system of FIG. 1 is capable of blogcasting according to the present invention by receiving a blog entry in a media file recorded on the handheld recording device (114); converting the recorded blog entry to text; identifying, in dependence upon the text, blog content; and publishing the blog content on one or more of the destination blog servers (106, 110, and 108).

The arrangement of devices making up the exemplary system illustrated in FIG. 1 is for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

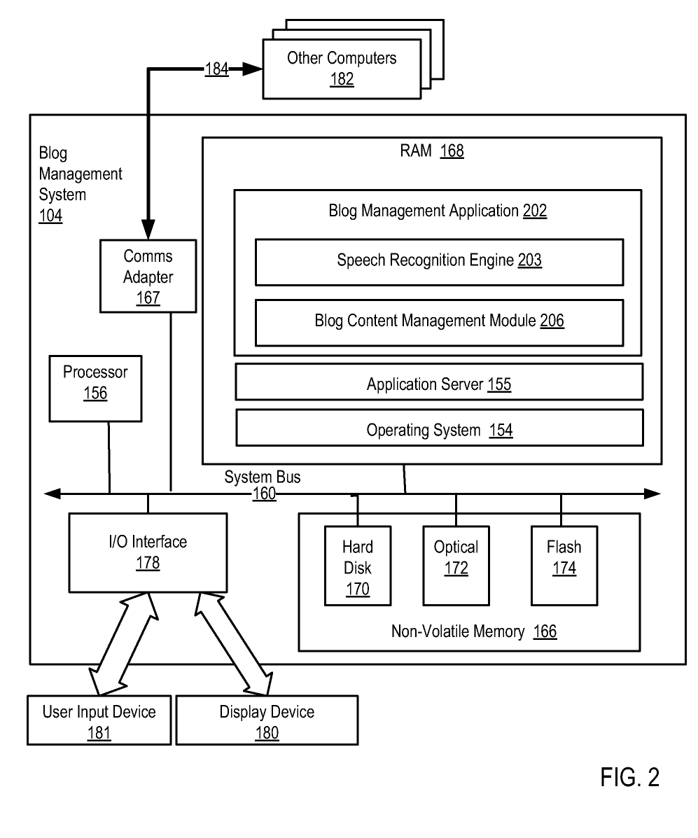

Blogcasting in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary blog management system (104) useful in blogcasting according to embodiments of the present invention. The blog management system (104) of FIG. 2 includes at least one computer processor (156) or ‘CPU’ as well as random access memory (168) (‘RAM’) which is connected through a system bus (160) to processor (156) and to other components of the blog management system.

Stored in RAM (168) is a blog management application (202) for blogcasting according to the present invention including computer program instructions for receiving a blog entry in a media file recorded on the handheld recording device; converting the recorded blog entry to text; identifying, in dependence upon the text, blog content; and publishing the blog content either locally or on one or more destination blog servers.

The blog management application (202) of FIG. 2 includes a speech recognition engine (203), computer program instructions for converting a recorded blog entry in a media file to text. Examples of speech recognition engines capable of modification for use with blog management applications according to the present invention include SpeechWorks available from Nuance Communications, Dragon NaturallySpeaking also available from Nuance Communications, ViaVoice available from IBM®, Speech Magic available from Philips Speech Recognition Systems, iListen from MacSpeech, Inc., and others as will occur to those of skill in the art.

The blog management application (202) of FIG. 2 includes a blog content management module (206), computer program instructions for receiving a blog entry in a media file recorded on the handheld recording device; identifying, in dependence upon the text converted from the blog entry recorded in the media file, blog content; and publishing the blog content either locally or on one or more destination blog servers.

Also stored in RAM (168) is an application server (155), a software platform that provides services and infrastructure required to develop and deploy business logic necessary to provide web clients with access to enterprise information systems. Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. Operating system (154) and blog management module (202) in the example of FIG. 2 are shown in RAM (168), but many components of such software typically are stored in non-volatile memory (166) also.

Blog management system (104) of FIG. 2 includes non-volatile computer memory (166) coupled through a system bus (160) to processor (156) and to other components of the blog management system (104). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary blog management system of FIG. 2 includes one or more input/output interface adapters (178). Input/output interface adapters in blog management systems implement user-oriented input/output through, for example, software drivers and computer hardware for controlling output to display devices (180) such as computer display screens, as well as user input from user input devices (181) such as keyboards and mice.

The exemplary blog management system (104) of FIG. 2 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for blogcasting according to embodiments of the present invention include modems for wired dial-up communications, Ethernet (IEEE 802.3) adapters for wired network communications, and 802.11b adapters for wireless network communications.

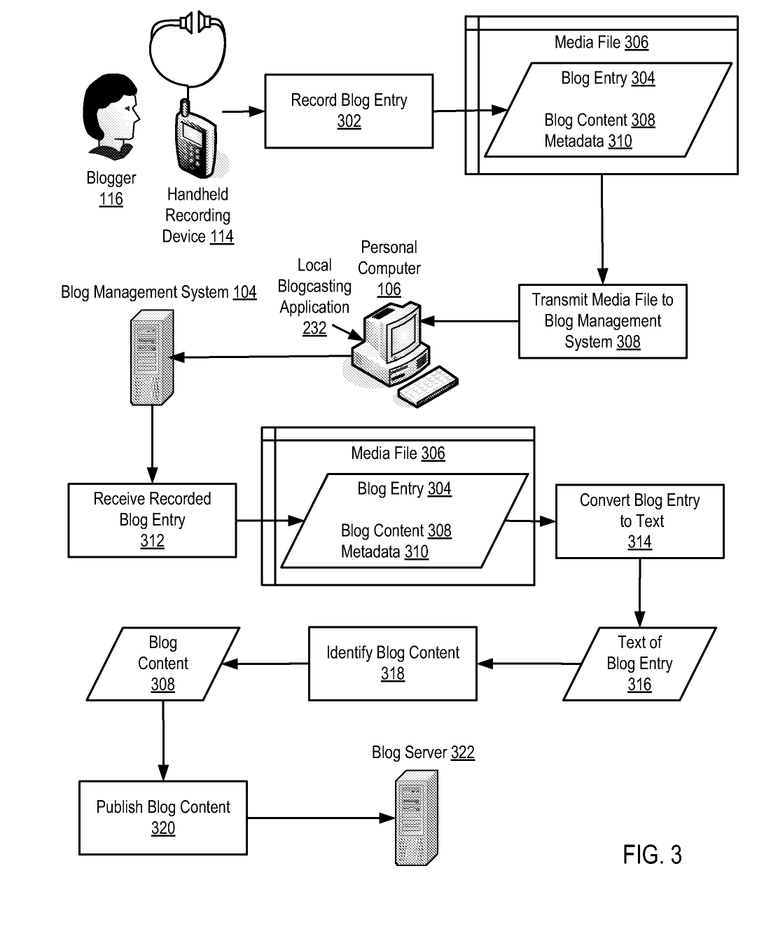

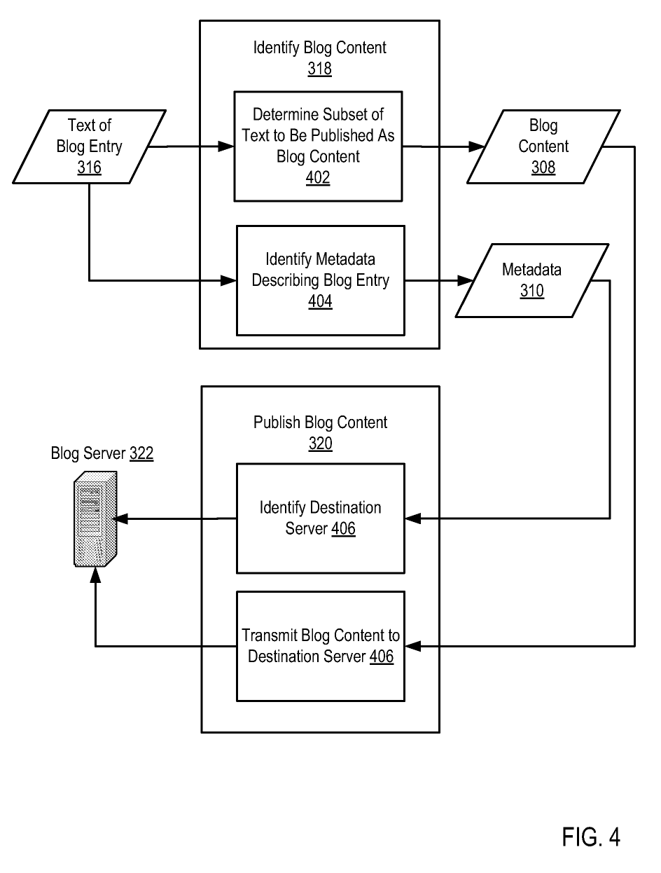

For further explanation, FIG. 3 sets forth a flow chart illustrating an exemplary method for blogcasting according to embodiments of the present invention. The method of FIG. 3 includes recording (302) in a media file (306) by a handheld recording device (114) a blog entry (304). In the example of FIG. 3, recording (302) in a media file (306) by a handheld recording device (114) a blog entry (304) includes recording a speech blog entry on a handheld recording device (114) in a media file (306) of the data format supported by the handheld recording device (114). Examples of media files useful in blogcasting according to the present invention include MPEG 3 (‘.mp3’) files, MPEG 4 (‘.mp4’) files, Advanced Audio Coding (‘AAC’) compressed files, Advances Streaming Format (‘ASF’) Files, WAV files, and many others as will occur to those of skill in the art.

The blog entry (304) of FIG. 3 includes blog content (308) and metadata (310) describing the blog entry. Blog content is text content to be published in the boggers blog. That is, the actual content to be published. Such blog content in the example of FIG. 3 is a subset of the recorded blog entry. Metadata (310) describing the blog entry is information describing the blog entry such as an identification of a type of blog, an identification of the destination blog server for publication of the blog entry, date and time information, and other information describing the blog entry as will occur to those of skill in the art.

The method of FIG. 3 includes transmitting (308) the media file (306) to a blog management system (104). As discussed above, transmitting (308) the media file (306) to a blog management system (104) includes synchronizing the handheld recording device (114) with a local blogcasting application (232) which in turns uploads the media file to the blog management system (104). Synchronizing the handheld recording device (114) with a local blogcasting application (232) advantageously allows a blogger to record blog entries at the blogger's convenience and also allows the blogger to initiate the sending of those blog entries to the blog management system (104) at the blogger's convenience.

The method of FIG. 3 includes receiving (312), by a blog management system (104), a blog entry (304), the blog entry (304) comprising speech recorded on a handheld recording device (114) in a media file (306). Local blogcasting applications (232) according to the present invention may be configured to upload blog entries from a blogger to a blog management system (104) periodically, such as daily, hourly and so on, or upon synchronization with handheld recording devices, or in any other manner as will occur to those of skill in the art.

The method of FIG. 3 also includes converting (314) the recorded blog entry (304) to text (316). Converting (314) the recorded blog entry (304) to text (316) may be carried out by a speech recognition engine. Speech recognition is the process of converting a speech signal to a set of words, by means of an algorithm implemented as a computer program. Different types of speech recognition engines currently exist. Isolated-word speech recognition systems, for example, require the speaker to pause briefly between words, whereas a continuous speech recognition systems do not. Furthermore, some speech recognition systems require a user to provide samples of his or her own speech before using them, whereas other systems are said to be speaker-independent and do not require a user to provide samples.

To accommodate larger vocabularies, speech recognition engines use language models or artificial grammars to restrict the combination of words and increase accuracy. The simplest language model can be specified as a finite-state network, where the permissible words following each word are explicitly given. More general language models approximating natural language are specified in terms of a context-sensitive grammar.

Examples of commercial speech recognition engines currently available include SpeechWorks available from Nuance Communications, Dragon NaturallySpeaking also available from Nuance Communications, ViaVoice available from IBM®, Speech Magic available from Philips Speech Recognition Systems, iListen from MacSpeech, Inc., and others as will occur to those of skill in the art.

The method of FIG. 3 also includes identifying (318), in dependence upon the text (316), blog content (308). Identifying (318), in dependence upon the text (316), blog content (308) may be carried out by determining in dependence upon the text a subset of text to be published as blog content and identifying, in dependence upon the text, metadata describing the blog entry as discussed below with reference to FIG. 4.

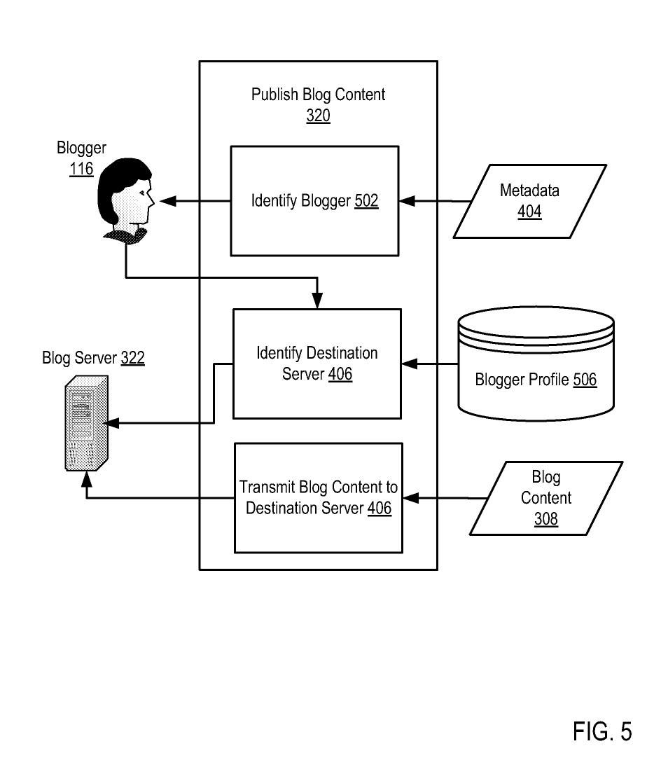

The method of FIG. 3 also includes publishing (320) the blog content (308). The blog content may be published either locally or on one or more destination blog servers. Publishing (320) the blog content (308) may be carried out by identifying a destination server for publication of the blog content in dependence upon the metadata and transmitting the blog content to the destination server as discussed below with reference to FIG. 4. Publishing (320) the blog content (308) may also be carried out by identifying the blogger in dependence upon the metadata and identifying a destination server for publication of the blog content in dependence upon the identification of the blogger as discussed below with reference to FIG. 5. As discussed above, blogcasting according to the present invention includes identifying blog content and publishing the blog content. For further explanation, therefore, FIG. 4 sets forth a flow chart illustrating a method for identifying, in dependence upon the text, blog content and a method for publishing the blog content. In the method of FIG. 4, identifying (318), in dependence upon the text (316), blog content (308) is carried out by determining (402) in dependence upon the text (316) a subset of text (308) to be published as blog content and identifying (404) in dependence upon the text (316) metadata (310) describing the blog entry. As mentioned above, blog content is the content to be actually published and is often a subset of the speech recorded in the blog entry. Metadata (310) describing the blog entry is information describing the blog entry such as an identification of a type of blog, an identification of the destination blog server for publication of the blog entry, date and time information, and other information describing the blog entry as will occur to those of skill in the art.

Consider for example the following brief web blog recorded as speech:
“This is blogger 121. This blog is to be posted on my entertainment blog. I hated the movie ‘Some Blockbuster’ ”

In the exemplary blog entry above, only the phrase ‘I hated the movie ‘Some Blockbuster’ is blog content. That is, content to be actually published on the entertainment blog. The phrase ‘This is blogger 121. This blog is to be posted on my entertainment blog’ is metadata describing the identification of the blogger and the destination blog upon which the blog content is to be published.

Distinguishing between blog content and metadata may be carried out by rules predetermined to identify blog content and metadata. Such rules may be configured by a user such that the user is aware of specific phrases used by the rules to distinguish metadata from blog content.

In the method of FIG. 4, publishing (320) the blog content (308) is carried out by identifying (406) a destination server (322) for publication of the blog content (308) in dependence upon the metadata (404). Identifying (406) a destination server (322) for publication of the blog content (308) in dependence upon the metadata (404) may be carried out by parsing the text identified as metadata and comparing the text to textual identifications of known destination blog servers. Such textual identifications may be maintained in association with a blogger profile containing information about the blogger.

In the method of FIG. 4, publishing (320) the blog content (308) is also carried out by transmitting (406) the blog content (308) to the destination server (322). Transmitting (406) the blog content (308) to the destination server (322) may also include providing security information to the destination server such only authorized blog content is transmitted to the destination server and therefore ultimately published for the blogger.

For further explanation, FIG. 5 sets forth another method for publishing blog content. In the method of FIG. 5, publishing (320) the blog content (308) includes identifying (502) the blogger (116) in dependence upon the metadata (404). As discussed above, the metadata may include an identification of the blogger. Alternatively, a blogger may be linked exclusively with a particular recording device such that any blog entries recorded on that handheld recording device are identified as being recorded by that particular blogger.

In the method of FIG. 5, identifying (406) a destination server (322) for publication of the blog content (308) in dependence upon the metadata (404) is carried out by identifying a destination server (322) for publication of the blog content in dependence upon the identification of the blogger (166). Identifying a destination server (322) for publication of the blog content in dependence upon the identification of the blogger (166) may be carried out by identifying a destination server in dependence upon a blogger profile (506). Often, in such cases, a single destination server is associated with a particular blogger and the therefore upon identifying the blogger the destination server identification may be retrieved from the blogger profile (506).

The method of FIG. 5 also includes transmitting the blog content to the destination server. As mentioned above, transmitting (406) the blog content (308) to the destination server (322) may also include providing security information to the destination server such only authorized blog content is transmitted to the destination server and therefore ultimately published for the blogger.

Exemplary embodiments of the present invention are described largely in the context of a fully functional computer system for blogcasting. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for blogcasting, the method comprising:
receiving, by a blog management system, a blog entry, the blog entry comprising speech recorded on a handheld recording device in a media file;
converting the recorded blog entry to text;
identifying, in dependence upon the text, blog content; and
publishing the blog content.

2. The method of claim 1 wherein identifying, in dependence upon the text, blog content further comprises:
determining, in dependence upon the text, a subset of the text to be published as blog content; and
identifying, in dependence upon the text, metadata describing the blog entry.

3. The method of claim 2 wherein publishing the blog content further comprises:
identifying a destination server for publication of the blog content in dependence upon the metadata; and
transmitting the blog content to the destination server.

4. The method of claim 3 wherein publishing the blog content further comprises identifying the blogger in dependence upon the metadata and wherein:
identifying a destination server for publication of the blog content in dependence upon the metadata further comprises identifying a destination server for publication of the blog content in dependence upon the identification of the blogger.

5. The method of claim 1 wherein publishing the blog content further comprises:
identifying a destination server in dependence upon a blogger profile; and
transmitting the blog content to the destination server.

6. The method of claim 1 further comprising:
recording in a media file by a handheld recording device a blog entry; and
transmitting the media file to a blog management system.

7. A system for blogcasting, the system comprising a computer processor, a computer memory operatively coupled to the computer processor, the computer memory having disposed within it computer program instructions capable of:
receiving, by a blog management system, a blog entry, the blog entry comprising speech recorded on a handheld recording device in a media file;
converting the recorded blog entry to text;
identifying, in dependence upon the text, blog content; and
publishing the blog content.

8. The system of claim 7 wherein computer program instructions capable of identifying, in dependence upon the text, blog content further comprise computer program instructions capable of:
determining, in dependence upon the text, a subset of the text to be published as blog content; and
identifying, in dependence upon the text, metadata describing the blog entry.

9. The system of claim 8 wherein computer program instructions capable of publishing the blog content further comprise computer program instructions capable of:
identifying a destination server for publication of the blog content in dependence upon the metadata; and
transmitting the blog content to the destination server.

10. The system of claim 9 wherein computer program instructions capable of publishing the blog content further comprise computer program instructions capable of identifying the blogger in dependence upon the metadata and wherein:
computer program instructions capable of identifying a destination server for publication of the blog content in dependence upon the metadata further comprise computer program instructions capable of identifying a destination server for publication of the blog content in dependence upon the identification of the blogger.

11. The system of claim 7 wherein computer program instructions capable of publishing the blog content further comprise computer program instructions capable of:
identifying a destination server in dependence upon a blogger profile; and
transmitting the blog content to the destination server.

12. The system of claim 7 wherein the computer memory also has disposed within it computer program instructions capable of:
recording in a media file by a handheld recording device a blog entry; and
transmitting the media file to a blog management system.

13. A computer program product for blogcasting, the computer program product embodied on a computer-readable medium, the computer program product comprising:
computer program instructions for receiving, by a blog management system, a blog entry, the blog entry comprising speech recorded on a handheld recording device in a media file;
computer program instructions for receiving converting the recorded blog entry to text;
computer program instructions for receiving identifying, in dependence upon the text, blog content; and
computer program instructions for receiving publishing the blog content.

14. The computer program product of claim 13 wherein computer program instructions for receiving identifying, in dependence upon the text, blog content further comprise:
computer program instructions for receiving determining, in dependence upon the text, a subset of the text to be published as blog content; and
computer program instructions for receiving identifying, in dependence upon the text, metadata describing the blog entry.

15. The computer program product of claim 14 wherein computer program instructions for receiving publishing the blog content further comprise:
computer program instructions for receiving identifying a destination server for publication of the blog content in dependence upon the metadata; and
computer program instructions for receiving transmitting the blog content to the destination server.

16. The computer program product of claim 15 wherein computer program instructions for receiving publishing the blog content further comprise computer program instructions for receiving identifying the blogger in dependence upon the metadata and wherein:
computer program instructions for receiving identifying a destination server for publication of the blog content in dependence upon the metadata further comprise computer program instructions for receiving identifying a destination server for publication of the blog content in dependence upon the identification of the blogger.

17. The computer program product of claim 13 wherein computer program instructions for receiving publishing the blog content further comprise:
computer program instructions for receiving identifying a destination server in dependence upon a blogger profile; and
computer program instructions for receiving transmitting the blog content to the destination server.

18. The computer program product of claim 13 further comprising:
computer program instructions for receiving recording in a media file by a handheld recording device a blog entry; and
computer program instructions for receiving transmitting the media file to a blog management system.

19. The computer program product of claim 13 wherein the computer readable medium comprises a recordable medium.

20. The computer program product of claim 13 wherein the computer readable medium comprises a transmission medium.
